(19) United States
(12) Patent Application Publication
(10) Pub. No.: US 2011/0315778 A1
(43) Pub. Date: Dec. 29, 2011

(54) CASING ELEMENTS AND DEVICES AND METHODS FOR ALLOCATING IDENTIFIERS TO CASING ELEMENTS

(75) Inventors: Michael KRUPP, Nuernberg (DE); Wolfram STRAUSS, Fuerth (DE); Gerritt HOEPPNER, Nuernberg (DE); Fritz MEIER, Nuernberg (DE); Alexander PFLAUM, Erlangen (DE); Sebastian KRAUS, Erlangen (DE); Christoph GRABOWSKI, Nuernberg (DE)

(73) Assignee: Fraunhofer-Gesellschaft zur Foerderung der angewandten Forschung e.V., Munich (DE)

(21) Appl. No.: 13/169,108

(22) Filed: Jun. 27, 2011

Related U.S. Application Data
(60) Provisional application No. 61/359,441, filed on Jun. 29, 2010.

(30) Foreign Application Priority Data
Jul. 27, 2010 (DE) 102010038474.7

(51) Int. Cl. G06K 19/077

(52) U.S. Cl. 235/492

(57) ABSTRACT

A casing element includes a casing frame and a casing shell spanning at least one opening in the casing frame. An RFID tag is arranged at or within a portion of the casing shell spanning the opening of the casing frame.

### CROSS-REFERENCE TO RELATED APPLICATIONS

This application claims priority from German Patent Application No. 102010038474.7, which was filed on Jul. 27, 2010, and from U.S. patent application Ser. No. 61/359,441, which was filed on Jun. 29, 2010, and which are both incorporated herein in their entirety by reference.

### BACKGROUND OF THE INVENTION

The present invention relates to the casing elements with allocated identifiers and to devices and methods for allocating identifiers to casing elements.

In contrary to stationary industry, the building sector deals with immobile products, which are mostly produced, i.e. built, at the later location of use. Project-specific production flows have to be managed and are usually only applicable for a specific project or building. In a correspondingly flexible manner, resources, such as casing elements, i.e. construction casings, are allocated to specific projects or building sites.

Due to the plurality and diversity and at the same time difficult discernability of the individual parts, construction devices, such as casing elements are expensive to manage and to administrate, wherein a plurality of casing parts are used both at large building sites and in small projects.

The casing elements are used for lining site concrete, such as liquid concrete, wherein the casing elements serve to seal a cavity that will later be filled with liquid concrete. Thereby, either specifically produced casings or standard casing elements can be used. Standard casings consist of a steel frame and a coating of plastic or wood, the casing shell. Standard casings are returned to the storage area and prepared for renewed usage.

Due to high investment costs, building contractors generally only hold a limited number of construction devices, wherein, depending on the workload of the company, construction devices are additionally rented for specific projects. Like all resources, construction devices are also centrally planned, wherein construction devices rented according to plan and construction devices belonging to the company are delivered to the building site. There, they are used and are subsequently returned to the hirer or the company's storage area. In order to enable discernability between own construction devices and rented construction devices, it is known to provide automatic identification for construction devices, such as casing elements.

In order to be able to identify casing elements, two solutions are currently tested or applied in the field of RFID technology. The company Paschal, a casing renter has developed a RFID solution using high-frequency RFID tags and attaches the same within the metallic frame of the casing. This solution is described in DE-A1-102007008303. However, it is a disadvantage of the solution described there that reading out the RFID tag is only possible from a very short distance due to the low range of the used technology. Thus, pile detection cannot take place as a significant potential benefit. Thereby, the described technology rather supports the processes in the storage area than to the much more interesting processes on the building site.

A further solution of using RFID technology is the attachment of a UHF tag with slot antenna. This technology necessitates a small gap in the metallic frame and allows reading out the tag from a large distance. The options of such a usage are currently examined in research projects ForBau at the Technical University of Munich and the ARGE RFID at the University of Wuppertal. However, only limited pile detection is possible here, due to the limited behavior of the slot antenna as well as due to problems regarding the static regulations when installing slots in casing frames.

Both described RFID approaches additionally raise significant economic questions, since the question of retrofitting an existing stock of casing elements remains unclear. Both when using HF technology and when attaching tags having slot antennas, manipulation of casing frames is necessitated. Thus, retrofitting existing casing stocks is difficult from the point of economic considerations, which has the effect that building contractors would have to tend to parallel casing stocks, namely with and without identification, which is a hardly acceptable solution.

### SUMMARY

According to an embodiment, a casing element may have: a casing frame; a casing shell spanning at least one opening in the casing frame; and an RFID tag attached to or within a portion of the casing shell spanning the opening of the casing frame.

According to another embodiment, a device for allocating identifiers to casing elements may have: a memory where a frame identifier and a current casing shell identifier are stored for each of a plurality of casing elements, wherein the device is implemented to replace the current casing shell identifier by a new current casing shell identifier when the casing shell of a casing shell element is replaced.

According to another embodiment, a method for allocating identifiers to casing elements may have the steps of: storing a frame identifier and a current casing shell identifier for each of a plurality of casing elements in a memory; and replacing the current casing shell identifier by a new current casing shell identifier when the casing shell of a casing element is replaced.

Another embodiment may have a computer program product having a program code that is effective to perform the inventive method, when the computer program product runs on a computer.

In embodiments of the invention, the RFID tag is a UHF-RFID tag. UHF-RFID technology basically allows the detection of several tags simultaneously and hence supports counting processes. Additionally, with UHF, reading out from a large distance is possible, which significantly simplifies processes on the building site. In the same manner, usage in the storage area is possible.

Thus, embodiments of the present invention allow automated identification of casing elements, which, for example, significantly simplifies discernability of own casings and rented casings and saves manual effort. Embodiments of the invention allow continuous stock control, such that a flexible and mobile usage of casing elements on different building sites can be implemented much more efficiently. Thus, embodiments of the invention allow knowledge of the current stock and the current place of usage of the casing elements, which eases the dispatch of casing elements.

According to the invention, RFID tags are not attached to the casing frame of casing elements, which can be standard casing elements, but at or in the casing shell spanning at least one opening in the casing frame. This allows the usage of UHF technology for identifying casing elements. By respectively attaching the RFID tags, the disturbing influence of the normally metallic frames, e.g. massive steel frames of the casing elements on a measurement is reduced, such that also the identification of stacked casing elements is possible. Thus, embodiments of the invention allow the detection of casing elements arranged in a pile, which allows counting and identifying the casing elements both when delivering the casings to the building site and prior to return delivery to the storage area. Thus, the casing elements can be checked for completeness. This allows effort reduction compared to manual counting and further extremely reduces proneness to errors. Thus, embodiments of the invention allow complete documentation of casing outputs and inputs both on building sites and in storage areas, which can lead to significant reduction of loss of casing elements.

Normally, standard casing elements are overhauled after several usages, wherein, for example, the wood casing shells or plastic casing shells are replaced. For the dispatcher, the state of the casing elements is not transparent or only with increased effort, for example, by going into the storage area or by calling the building site. Embodiments of the invention allow the storage of data regarding usage of casing elements, such that life cycle documentation of the casing, maintenance history and/or state information regarding individual elements is available, allowing simple organization of maintenance work.

Thus, embodiments of the invention allow the usage of RFID technology at casing elements, in particular standard casings, which allows a significant reduction of manual activities, avoidance of errors in the process, increasing stock transparency, increasing resource usage as well as avoidance of loss.

### BRIEF DESCRIPTION OF THE DRAWINGS

Embodiments of the present invention will be detailed subsequently referring to the appended drawings, in which:

FIG. 1 is a schematic perspective view of a casing element according to an embodiment of the invention;

FIG. 2 is a schematic view of a device for detecting identifiers of a stack of casing elements; and

FIG. 3 is an embodiment of a device for allocating identifiers to casing elements.

### DETAILED DESCRIPTION OF THE INVENTION

The term “RFID tag” is used here with its common meaning. In embodiments of the invention, the RFID tag comprises a microchip, an antenna and a carrier or a housing by which the RFID tag is attached to or within the object, i.e. the casing element. In embodiments of the invention, the transponder is a passive transponder.

The identifier stored in the RFID tag can be read out when the RFID tag reaches the reading area of the antenna of the reading device. In embodiments of the invention, the RFID tag is a UHF RFID tag designed for a frequency in the UHF range. Here, UHF range means a frequency band of approximately 0.3 GHz to 3 GHz, wherein standard RFID tags operate, for example, at typical frequencies of 433 MHz and 868 MHz in Europe, 915 MHz in the USA and 950 MHz in Japan.

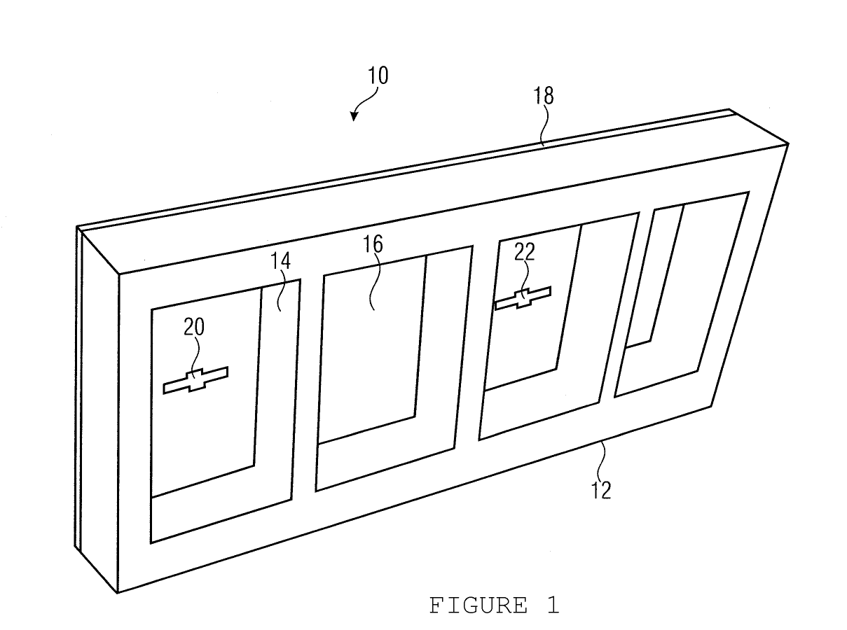

An embodiment of an inventive casing element 10 is shown in FIG. 1. The casing element 10 can have the shape and dimensions of a standard casing element. Typical dimensions of standard casing elements are 54×14×120 cm or 64×14×120 cm. The casing element 10 comprises a casing frame 12 consisting, for example, of metal, such as steel. The casing frame 12 comprises transverse bracings 14, such that four openings 16 are formed through the casing frame 12. These openings 16 are spanned by a casing shell 18, which is attached to the rear side of the plastic frame 12 in the illustration in FIG. 1. The casing shell 18 can be formed, for example, by a plastic plate, a multiplex plate or a wooden plate. Insofar, the casing element shown in FIG. 1 corresponds to a standard casing element.

As shown in FIG. 1, one RFID tag 20 or 22 each is attached at two areas of the casing shell 18, each of which is spanning one opening 16. The RFID tags 20, 22 are attached to the casing shell 18 such that detachment of the same is prevented. The RFID tags 20, 22 can be integrated, for example, into the casing shell 18. Alternatively, the RFID tags 20, 22 can be connected in an undetachable manner to the inside of the casing shell 18 facing the casing frame 12, for example, by using a respective adhesive. The RFID tags can be implemented, for example, by an Alien®-H2 transponder. As shown in FIG. 1, the RFID tags can be orientated in a horizontal or vertical manner when the casing element is lying. The RFID tags 20 and 22 can comprise identical identifiers. The RFID tags can be arranged over the respective opening in the casing frame according to aspects optimized as regards to reception, for example, centrally above the respective opening.

While a casing element having two RFID tags is shown in FIG. 1, it is obvious to a person skilled in the art that a lower or higher number of RFID tags can be provided, wherein, as also obvious to a person skilled in the art, a higher number of RFID tags can have a positive effect on the probability of a successful readout.

The RFID tags are arranged such when stacking casing elements in a horizontal manner, reading out the RFID tags by a reading device is possible, since further casing shells can be arranged between the respective RFID tags and the reading device, but not casing frames that would not be transmissive for the radiation or radio waves used for reading out.

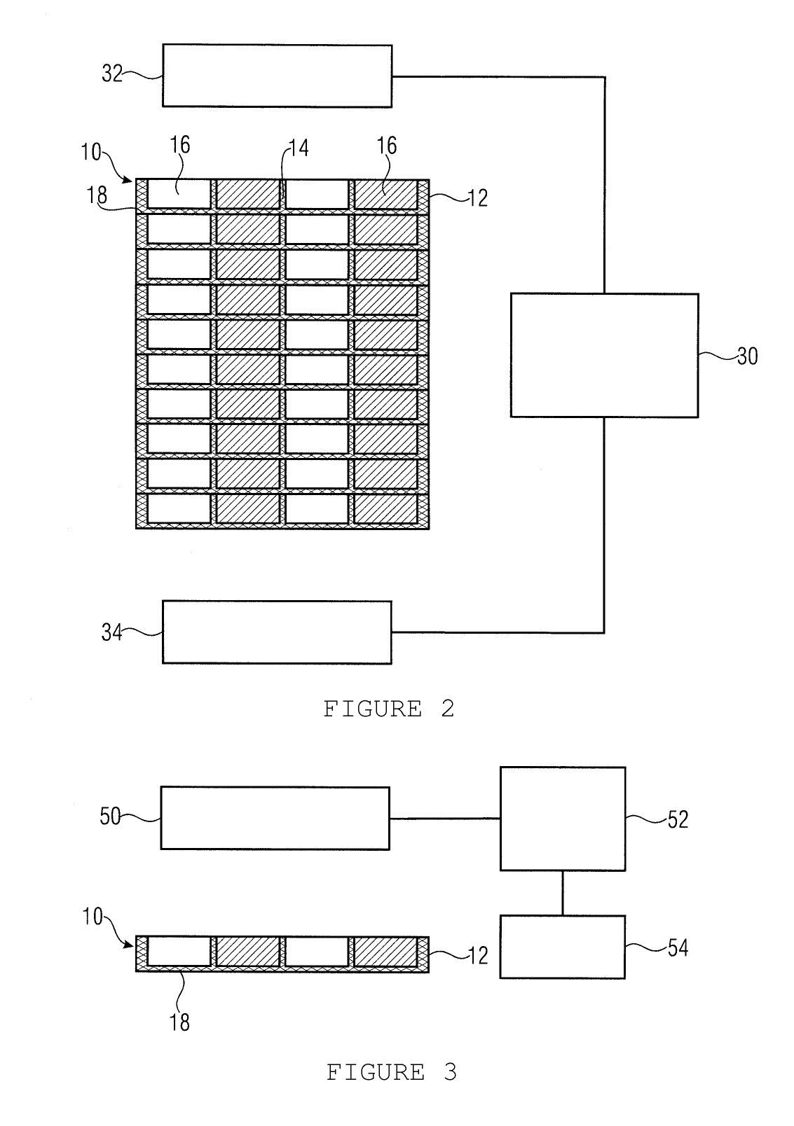

A pile of 10 stacked casing elements 10 is shown in FIG. 2, wherein the same or equal elements are provided with the same reference numbers. In the casing elements shown in FIG. 2, RFID tags are arranged respectively at areas of the casing shell 18 spanning the shaded openings 16. In FIG. 2, the stack of casing elements 10 is arranged between antennas 32 and 34 of reading device 30. The reading device can, for example, be a RFID reader available under the name SIRIT Infinity510, wherein the antennas 32 and 34 can be patch antennas from the company WIMO.

Measurements using the illustrated configurations have shown that all casing elements 10 of a respective stack can be detected. These measurements have shown that detecting all casing elements has in particular been possible when the stack has been passed dynamically between antennas 32 and 34. Thus, in embodiments of the present invention, a reading device can be implemented correspondingly to allow passing a pile of stacked casing elements, wherein a top and bottom antenna 32, 34 are arranged at an appropriate distance to the top or bottom of the stack.

For detecting a stack having a lower number of casing elements, it can also be sufficient to provide an antenna on only one side of the stack. In the case of horizontally aligned casing elements, antennas 32, 34 are provided below and/or above the stack. With a pile of casing elements arranged in a standing manner beside one another, antennas can also be arranged on one or both sides beside the pile, such that the radiation necessitated for reading out can penetrate the casing shells of a plurality of casing elements. In the embodiment shown in FIG. 2, a measurement from the side is not possible, since the massive steel frame of the casing elements cannot be penetrated by radio waves.

The stated test measurements have shown that with a static measurement with two antennas on one side of a horizontal stack, reading could be performed up to a stacking height of six casing elements. Increasing the readability in the static measurement resulted when arranging an antenna on each side of the horizontal stack. The static measurement shows that the RFID tags arranged more centrally could be read better. Dynamic measurements where the casing element stack has been passed along the antennas showed that the detection rate could be improved by dynamic measurement, in particular, by using the dynamic measurement the RFID tag arranged further to the outside could also be detected better. It has been shown that during a passage of a stack of 10 casing elements of the described type through an antenna gate of top and bottom antenna, all casing elements could be detected. Thereby, the antennas were arranged in a distance of 20 cm from the top or bottom end of the stack. Increasing the antenna distance showed that the RFID tags arranged more centrally could still be read, wherein, however, the detection rate of the RFID tags arranged at the outside decreased quicker.

In embodiments of the invention, the casing frame comprises a plurality of openings including outer and inner openings, wherein the RFID tag or one of a plurality of RFID tags is arranged at or within a portion of the casing shell spanning an inner opening.

In summary, it has to be stated that the performed test measurements showed that embodiments of the invention allow an identification of a plurality of casing elements in a pile by means of RFID technology. Embodiments of the invention relate to methods for detecting an identity of casing elements arrangements in a pile, wherein the pile is moved dynamically through the reading field of a stationary or mobile reading device. Detecting the identity of the casing elements in the casing structure is also possible, wherein a mobile reading device is moved along the casing structure for generating a dynamic reading field. In embodiments, every casing element is provided with several RFID tags for increasing detection reliability.

In embodiments of the invention, RFID tags are introduced into the casing shells of casing elements. Normally, casing shells of standard casings are regularly replaced. Thus, in order to allow continuous stock control and dispatch, embodiments of the present invention provide a device and a method for allocating identifiers to casing elements allowing continuous identification even when exchanging casing shells. Embodiments of such a device comprise a memory where a frame identifier and at least one current casing shell identifier is stored for each of a plurality of casing elements.

The device is implemented to replace the current casing shell identifier by a new current casing shell identifier when the casing shell of a casing element is replaced. An embodiment of such a device is shown schematically in FIG. 3. The device comprises an antenna 50 coupled to a reading device 52 coupled to a memory 54. The memory 54 can, for example, be a memory of a conventional computer used for continuous stock control and dispatch of casing elements.

In embodiments of the invention, a casing shell can comprise several RFID tags having different identifiers. In such a case, a plurality of casing shell identifiers can be stored and respectively replaced for the allocated casing element.

If the casing shell 18 of a casing element 10 is replaced, the casing shell to be replaced (i.e. the old one) is brought into the reading area of the antenna 50 such that the reading device 52 detects the allocated casing shell identifier. Based thereon, a casing element in the memory can be identified. Subsequently, the new casing shell is brought into the reading area of the antenna 50, such that the reading device 52 detects the casing shell identifier of the new casing shell and replaces the casing shell identifier allocated to the identified casing element by the casing shell identifier of the new casing shell in the memory.

Thus, so to speak, a virtual identity is allocated to the casing frame in the memory 54, wherein the casing shell identifier of the current casing shell is allocated to this virtual identity of the casing frame. It is also possible to store a history of casing shell identifiers (IDs) in the memory, wherein the last, i.e. current casing shell identifier is representative for the casing ID. By means of this casing shell identifier allocated to the casing element, the casing element can be identified.

In embodiments of the invention, the memory can be implemented to store, in a dataset allocated to a casing element, a history of casing shell identifiers that have been allocated to the casing element. In embodiments, the memory can further be implemented to store a maintenance history and/or state information of the casing element in the dataset, such that based on such stored data a replacement of the casing shell can be initiated or performed.

Thus, in embodiments of the invention, an replace of the casing shell is synchronized with the datasets in the allocated system as they are stored, for example, in memory 54.

Embodiments of the invention are related to respective software for directing a device for allocating identifiers to casing elements to update the allocated dataset correspondingly when changing casing shells.

Thus, embodiments of the present invention provide an identification of casing elements or standard casings via an identifier, such as an ID number attached to the casing shells, wherein a unique allocation of the dataset in the system to a casing can be ensured by allocating a frame identifier and a casing shell identifier to the casing in a respective dataset.

Thus, according to the invention, not the casing frames, but the casing shells are identified with a RFID tag. This allows, on the one hand, detecting a plurality of casing elements arranged in a pile. On the other hand, this solves advantageously the question of retrofit, since casing shells usually have to be replaced regularly (approximately after every tenth application). Thus, by using casing shells provided with RFID tags, it is possible to convert the whole stock of casings to RFID technology, for example within one to two years. This does not cause significant manual effort. The additional effort for equipping the casing shells with RFID tags is also limited, at a price per RFID tag of approximately 0.12 euros.

Depending on certain implementation requirements, the embodiments of the invention can be implemented in hardware or in software. For example, reading devices 30, 32 and memory 54 can be part of a system for continuous stock control and dispatch.

Generally, embodiments of the present invention can also be implemented as a computer program product having a program code, wherein the program code is effective to perform a method according to the invention when the computer program product runs on a computer. The program code can be stored, for example, on a machine-readable carrier, such as a floppy disk, a DVD, a Blue-Ray disc, a CD, a ROM or a PROM, an EPROM, an EEPROM or a FLASH memory, a hard disc or any other magnetic or optical memory. Such a computer program product can direct a computer to perform an embodiment of an inventive method, namely to store a frame identifier and a current casing shell identifier for each of a plurality of casing elements, wherein, when replacing casing shells, the current casing shell identifier is replaced by the casing shell identifier of the new casing shell.

While this invention has been described in terms of several advantageous embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. Casing element comprising:
a casing frame;
a casing shell spanning at least one opening in the casing frame; and
an RFID tag attached to or within a portion of the casing shell spanning the opening of the casing frame.

2. Casing element according to claim 1, wherein the RFID tag is arranged over the opening according to aspects optimized as regards to reception.

3. Casing element according to claim 1, wherein the RFID tag is implemented for the UHF frequency range.

4. Casing element according to claim 1, wherein several RFID tags comprising the same identifier are formed at or within portions of the casing shell spanning one or several openings of the casing frame.

5. Casing element according to claim 1, wherein the casing frame comprises a plurality of openings comprising outer and inner openings, wherein at least one RFID tag is arranged at or within a portion of the casing shell spanning an inner opening.

6. Casing element according to claim 1, wherein the casing shell can be replaced.

7. Device for allocating identifiers to casing elements, comprising:
a memory where a frame identifier and a current casing shell identifier are stored for each of a plurality of casing elements,
wherein the device is implemented to replace the current casing shell identifier by a new current casing shell identifier when the casing shell of a casing shell element is replaced.

8. Device according to claim 7, which is implemented to receive a casing shell identifier from a casing shell to be replaced, to identify the allocated casing element by accessing the memory, to receive a casing shell identifier of a new casing shell, and to replace the current casing shell identifier of the identified casing element by the new casing shell identifier.

9. Device according to claim 7, wherein the memory is further implemented to store data with regard to the usage of the casing elements.

10. Method for allocating identifiers to casing elements, comprising:
storing a frame identifier and a current casing shell identifier for each of a plurality of casing elements in a memory; and
replacing the current casing shell identifier by a new current casing shell identifier when the casing shell of a casing element is replaced.

11. A non-transitory computer readable medium including a computer program product comprising a program code that is effective to perform, when the computer program product runs on a computer, a method for allocating identifiers to casing elements, the method comprising:
storing a frame identifier and a current casing shell identifier for each of a plurality of casing elements in a memory; and
replacing the current casing shell identifier by a new current casing shell identifier when the casing shell of a casing element is replaced.
